(19) United States
(12) Patent Application Publication
(10) Pub. No.: US 2019/0349060 A1
(43) Pub. Date: Nov. 14, 2019

(54) Methods of Efficient Bandwidth Part Switching in a Wideband Carrier

(71) Applicant: MEDIATEK INC., Hsin-Chu (TW)

(72) Inventors: Pei-Kai Liao, Hsin-Chu (TW); Chia-Hao Yu, Hsin-Chu (TW)

(21) Appl. No.: 16/407,577

(22) Filed: May 9, 2019

Related U.S. Application Data
(60) Provisional application No. 62/670,104, filed on May 11, 2018.

(51) Int. Cl. H04B 7/06; H04L 5/00; H04W 72/04; H04W 76/27; H04W 72/12

(52) U.S. Cl. CPC H04B 7/0695; H04B 7/0626; H04W 72/1205; H04W 72/0453; H04W 76/27; H04L 5/005

(57) ABSTRACT

A method of sounding reference signal (SRS) transmission and channel state information (CSI) reporting during and after active bandwidth part (BWP) switching in a wireless communication system is proposed. In the uplink, if an SRS transmission is triggered when UE is operating in a first active UL BWP, and the SRS is scheduled for transmission when UE is operating in a second active UL BWP, then UE drops the SRS transmission. In the downlink, if a CSI report is triggered when UE is operating in a first active DL/UL BWP, and the CSI report is scheduled for transmission when UE is operating in a second active DL/UL BWP, then UE drops the CSI report.

### CROSS REFERENCE TO RELATED APPLICATIONS

This application claims priority under 35 U.S.C. § 119 from U.S. Provisional Application No. 62/670,104, entitled “Methods of efficient Bandwidth Part Switching in a Wideband Carrier,” filed on May 11, 2018, the subject matter of which is incorporated herein by reference.

### TECHNICAL FIELD

The disclosed embodiments relate generally to wireless network communications, and, more particularly, to bandwidth part (BWP) switching in 5G new radio (NR) wireless communications systems.

### BACKGROUND

Third generation partnership project (3GPP) and Long-Term Evolution (LTE) mobile telecommunication systems provide high data rate, lower latency and improved system performances. In 3GPP LTE networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition.

The bandwidth shortage increasingly experienced by mobile carriers has motivated the exploration of the underutilized Millimeter Wave (mmWave) frequency spectrum around 30 G and 300 GHz for the next generation 5G broadband cellular communication networks. The available spectrum of mmWave band is two hundred times greater than the conventional cellular system. The mmWave wireless network uses directional communications with narrow beams and can support multi-gigabit data rate. 5G new radio (NR) beamforming wireless systems support UEs operating with single wideband carrier and UEs operating with intra-band carrier aggregation over the same contiguous spectrum simultaneously.

Furthermore, to save power, NR introduces the concept of bandwidth part (BWP), which consist of a continuous range of physical resource blocks (PRBs) in frequency domain and whose occupied bandwidth is the subset of the bandwidth of the associated carrier. That is, the bandwidth of a BWP in a carrier is the subset of the carrier bandwidth, where the carrier bandwidth is divided into multiple continuous frequency band with a smaller bandwidth. UE can be configured by the network with several uplink (UL) BWPs and downlink (DL) BWPs, and UE is required to monitor at most one uplink BWP and downlink BWP at the same time. The downlink BWP and uplink BWP which is being used or monitored by the UE is called active BWP, e.g. active DL BWP and active UL BWP respectively. As a result, power consumption to monitor the downlink can be reduced because UE is only required to monitoring the smaller frequency range of the active BWP, rather than monitor the whole carrier bandwidth. Each uplink bandwidth part and downlink bandwidth part have their own identifier, i.e. a BWP ID. In FDD system (i.e., a paired spectrum system), UE can be operated in an active UL BWP and active DL BWP with different BWP ID (e.g. using UL BWP #1 and DL BWP 2); while for TDD system (i.e., an unpaired spectrum system), UE is always operated on a UL BWP and an DL BWP with the same BWP ID.

The activation or deactivation of BWPs can be achieved by radio resource control (RRC) signaling, downlink control information (DCI) scheduling with explicit indication, or a timer for a UE to switch its active DL BWP to a default DL BWP. However, active BWP switching may create the following issues. First, UE behavior for Sounding Reference Signal (SRS) transmission during and after active BWP switching. Second, UE behavior for Channel State Information (CSI) report during and after active BWP switching. Third, UE's assumption for Transmission Configuration Indication (TCI) or Sounding Resource Indication (SRI) during and after active BWP switching.

### SUMMARY

A method of sounding reference signal (SRS) transmission and channel state information (CSI) reporting during and after active bandwidth part (BWP) switching in a wireless communication system is proposed. In the uplink, if an SRS transmission is triggered when UE is operating in a first active UL BWP, and the SRS is scheduled for transmission when UE is operating in a second active UL BWP, then UE drops the SRS transmission. In the downlink, if a CSI report is triggered when UE is operating in a first active DL/UL BWP, and the CSI report is scheduled for transmission when UE is operating in a second active DL/UL BWP, then UE drops the CSI report.

In one embodiment, a UE receives configuration information transmitted from a base station in a wireless communications network. The UE is configured with multiple bandwidth parts (BWPs) in a carrier bandwidth. The UE operates on a first uplink BWP and a first downlink BWP. The UE receives a first downlink control information (DCI) for scheduling an uplink transmission. The UE receives a second DCI in the first downlink BWP for switching to a second uplink BWP or a second downlink BWP. The UE determines the scheduled uplink transmission based on the first DCI. The uplink transmission is scheduled to be transmitted in the first uplink BWP after the UE is triggered by the second DCI to switch to the second uplink BWP or the second downlink BWP, and the UE drops the scheduled uplink transmission.

In another embodiment, a UE receives configuration information transmitted from a base station in a wireless communications network. The UE is configured with multiple bandwidth parts (BWPs) in a carrier bandwidth. The UE operates on a first uplink BWP and a first downlink BWP. The UE receives a radio resource control (RRC) signaling for scheduling a channel state information (CSI) transmission. The UE receives a downlink control information (DCI) in the first downlink BWP for switching to a second uplink BWP or a second downlink BWP. The UE determines the scheduled CSI transmission for CSI measurement on the first downlink BWP based on the RRC signaling. The CSI transmission is scheduled to be transmitted in the first uplink BWP after the UE is triggered by the DCI to switch to the second uplink BWP or the second downlink BWP, and the UE drops the scheduled CSI transmission.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system supporting active bandwidth part (BWP) switching in accordance with a novel aspect.

FIG. 2 is a simplified block diagram of a wireless transmitting device and a receiving device in accordance with a novel aspect.

FIG. 3 illustrates a sequence flow between a base station and a user equipment for sounding reference signal (SRS) transmission with active BWP switching in a wireless communication system.

FIG. 4 illustrates a sequence flow between a base station and a user equipment for aperiodic channel state information (CSI) report with active BWP switching in a wireless communication system.

FIG. 5 illustrates a sequence flow between a base station and a user equipment for periodic channel state information (CSI) report with active BWP switching in a wireless communication system.

FIG. 6 illustrates a sequence flow between a base station and a user equipment for semi-periodic channel state information (CSI) report with active BWP switching in a wireless communication system.

FIG. 7 illustrates one embodiment of downlink data transmission based on Transmission Configuration Indication (TCI) assumption with active BWP switching in a wireless communication system.

FIG. 8 illustrates one embodiment of uplink data transmission based on Sounding Resource Indication (SRI) assumption with active BWP switching in a wireless communication system.

FIG. 9 is a flow chart of a method of SRS transmission during and after active BWP switching in a wireless communication system in accordance with one novel aspect.

FIG. 10 is a flow chart of a method of CSI reporting during and after active BWP switching in a wireless communication system in accordance with one novel aspect.

### DETAILED DESCRIPTION

Reference will now be made in detail to some embodiments of the invention, examples of which are illustrated in the accompanying drawings.

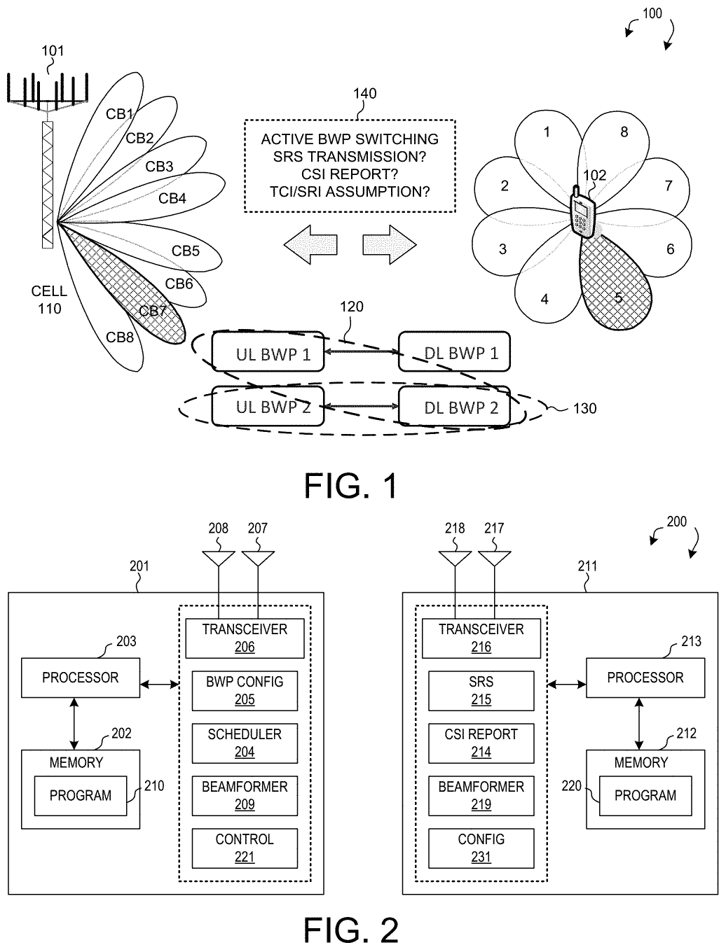

FIG. 1 illustrates a 5G wireless communications system 100 supporting active bandwidth part (BWP) switching in accordance with a novel aspect. 5G new radio (NR) mobile communication network 100 comprises a base station BS 101 and a user equipment UE 102. In the example of FIG. 1, BS 101 is directionally configured with multiple cells, and each cell is covered by a set of coarse TX/RX control beams. For example, cell 110 is covered by a set of eight downlink (DL) control beams CB1 to CB8. The collection of the DL beams CB1-CB8 covers an entire service area of a cell. Each DL beam transmits a set of known reference signals for the purpose of initial time-frequency synchronization, identification of the control beam that transmits the reference signals, and measurement of radio channel quality for the control beam that transmits the reference signals. In NR systems, each of the DL beams are used to transmit a corresponding system synchronization block (SSB) or a corresponding channel state information reference signal (CSI-RS).

When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI). The uplink control information (UCI) including HARQ ACK/NACK, CQI, MIMO feedback, scheduling requests is carried by a physical uplink control channel (PUCCH) or PUSCH if the UE has data or RRC signaling.

To save power, 5G NR introduces the concept of bandwidth part (BWP). Usage scenarios of BWP operation includes the following: 1) enabling reduced UE bandwidth capability within a wideband carrier; 2) enabling reduced UE power energy consumption by bandwidth adaptation; 3) enabling UE using different numerologies in FDM within a wideband carrier. For each UE-specific serving cell, one or more DL BWPs and one or more UL BWPs can be configured by dedicated RRC for a UE. Each UE can be configured by the network with several DL BWPs and UL BWPs, and UE is required to monitor at most one DL BWP and UL BWP at the same time. The DL BWP and UL BWP which is being monitored by the UE is called active BWP. For each UE, there is at most one active DL BWP and at most one active UL BWP at a given time for a serving cell. There is an initial active DL and UL BWP pair to be valid for a UE until the UE is explicitly (re)configured with BWPs during or after RRC connection is established. As a result, power consumption to monitor the downlink can be reduced because UE is only required to monitoring the smaller frequency range of the active BWP.

A BWP consists of a continuous range of physical resource blocks (PRB) in frequency domain and whose occupied bandwidth is the subset of the bandwidth of the associated carrier. That is, the bandwidth of a BWP in a carrier is the subset of the carrier bandwidth, and the bandwidth size ranges from the SS block bandwidth to the maximal bandwidth capability supported by a UE in a component carrier. A BWP may or may not contain SS block. Reserved resources can be configured within a BWP. For a connected-mode UE, one or multiple BPWs configurations for each component carrier can be semi-statically signaled to the UE and the configuration parameters include: numerology (i.e., CP type, subcarrier spacing); frequency location (the offset between BWP and a reference point is implicitly or explicitly indicated to UE) based on common PRB index for a given numerology; bandwidth size (in terms of PRBs); Control Resource Set (CORESET) (required for each BWP configuration in case of single active DL BWP for a given time instant).

Each DL/UL BWP has its own identified, i.e. BWP ID. In FDD system (i.e., a paired spectrum system), UE can be operated in an active DL BWP and active UL BWP with different BWP ID (e.g. using UL BWP #1 and DL BWP #2 as depicted by BWP pair 120); while for TDD system (i.e., an unpaired spectrum system), UE is always operated on an uplink BWP and downlink BWP with the same BWP ID (e.g., using UL BWP #2 and DL BWP #2 as depicted by BWP pair 130). This is because in TDD, a UE is not expected to retune the center frequency of channel BW between DL and UL if different active DL and UL BWPs are configured for the UE. At least one of configured BWPs includes one CORESET with common search space in PCELL. Each configured DL BWP includes at least one CORESET with UE-specific search space for the case of single active BWP at a given time per component carrier.

For active BWP operation, a UE is only assumed to receive or transmit within the active BWPs using the associated numerology—at least PDSCH and PDCCH for DL and PUCCH and PUSCH for UL. UE expects at least one DL BWP and UL BWP being active among the set of configured BWPs for a given time instant. In case of single active DL BWP for a given time instant in a component carrier, a UE can assume that PDSCH and corresponding PDCCH are transmitted within the same BWP if PDSCH transmission starts no later than K symbols after the end of the PDCCH transmission. In case of PDSCH transmission starts more than K symbols after the end of the corresponding PDCCH, PDCCH and PDSCH may be transmitted in different BWPs. The activation/deactivation of BWP can be done by dedicated RRC signaling, by DCI scheduling with explicit indication, or by a timer for a UE to switch is active DL BWP to a default DL BWP, e.g., the initial active BWP.

However, active BWP switching may create the following issues as depicted by 140. First, UE behavior for Sounding Reference Signal (SRS) transmission during and after active BWP switching. Second, UE behavior for Channel State Information (CSI) report during and after active BWP switching. Third, UE's assumption for Transmission Configuration Indication (TCI) and Sounding Resource Indication (SRI) during and after active BWP switching. In accordance with one novel aspect, a method of SRS transmission and CSI reporting during and after active BWP switching is proposed. In the uplink, if an SRS transmission is triggered when UE is operating in a first active UL BWP, and the SRS is scheduled for transmission when UE is operating in a second active UL BWP, then UE drops the SRS transmission. In the downlink, BS 101 provides opportunities for UE 102 to measure beamformed channel of different combinations of BS TX beams CB1-CB8 and UE RX beams 1-8. UE 102 measures beamformed channel state by using different UE RX beams 1-8 and reports CSI measurements to BS 101. If a CSI report is triggered when UE is operating in a first active DL/UL BWP, and the CSI report is scheduled for transmission when UE is operating in a second active DL/UL BWP, then UE drops the CSI report. UE may also assume TCI and SRI after active BWP switching during TCI/SRI warm-up period.

FIG. 2 is a simplified block diagram of wireless devices 201 and 211 in accordance with a novel aspect. For wireless device 201 (e.g., a base station), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a user equipment), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes a BWP configuration circuit 205, a scheduler 204, a beamforming circuit 209, and a control circuit 221. Wireless device 211 is a user equipment that includes an SRS handling circuit 215, a CSI reporting circuit 214, a beamforming circuit 219, and a configuration circuit 231. The different functional modules and circuits can be implemented and configured by software, firmware, hardware, and any combination thereof. The function modules and circuits, when executed by the processors 203 and 213 (e.g., via executing program codes 210 and 220), allow BS 201 and UE 211 to perform embodiments of the present invention accordingly.

In one example, BS 201 provides BWP configuration, activation, and switching for UE 211 via BWP configuration circuit 205. BS 201 schedules SRS transmission and CSI reporting via scheduler 204. BS 201 performs beamforming for directional communication via beamforming circuit 209, and provides other control information to UE 211 via controller 221. UE 211 transmits SRS to BS 201 via SRS handling circuit 215, and performs CSI measurements and transmits CSI report to BS 201 via CSI reporting circuit 214. UE 211 performs beamforming for direction communication via beamforming circuit 219, and handles BWP configuration, activation, and switching via configuration circuit 231. UE determines whether to drop a scheduled SRS transmission and CSI report based on when such SRS transmission and/or CSI report is triggered and scheduled, and whether active BWP switching has happened after the triggering and scheduling.

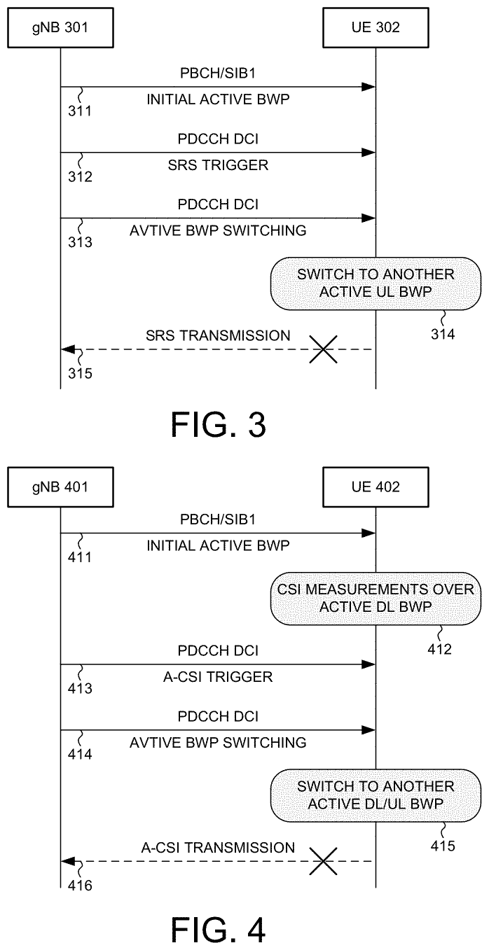

FIG. 3 illustrates a sequence flow between a base station and a user equipment for sounding reference signal (SRS) transmission with active BWP switching in a wireless communication system. In step 311, UE 302 receives configuration from gNB 301, e.g., from a physical broadcast channel (PBCH)/SIB1. UE 302 is configured with multiple DL and UL BWPs, and operates in an active DL BWP and an active UL BWP. In step 312, UE 302 receives a first PDCCH carrying a first DCI. The first DCI schedules the UE to transmit an SRS over an allocated uplink radio source at a later time. In step 313, UE 302 receives a second PDCCH carrying a second DCI. The second DCI instructs the UE to switch the active UL BWP from the first UL BWP to a second UL BWP. In step 314, UE 302 performs the active BWP switching, and UE 302 operates in the second UL BWP accordingly. In step 315, UE 302 determines that the SRS is scheduled to be transmitted to gNB 301. However, the allocated uplink radio resource for the SRS transmission is associated with the previous active UL BWP, and may no longer be valid because the UE is already operating in the new active UL BWP. As a result, UE 302 decides to drop the scheduled SRS transmission.

FIG. 4 illustrates a sequence flow between a base station and a user equipment for aperiodic channel state information (CSI) report with active BWP switching in a wireless communication system. In step 411, UE 402 receives configuration from gNB 401, e.g., from a physical broadcast channel (PBCH)/SIB1. UE 402 is configured with multiple DL and UL BWPs, and operates in an active DL BWP and an active UL BWP. In step 412, UE 402 performs CSI measurements over the active DL BWP. In step 413, UE 402 receives a first PDCCH carrying a first DCI. The first DCI schedules the UE to transmit an aperiodic CSI (a-CSI) report over an allocated uplink radio source at a later time. In step 414, UE 402 receives a second PDCCH carrying a second DCI. The second DCI instructs the UE to switch the active DL BWP from the first DL BWP to a second DL BWP, and/or switch the active UL BWP from the first UL BWP to a second UL BWP. In step 415, UE 402 performs the active BWP switching, and UE 402 operates in the second DL BWP and/or the second UL BWP accordingly. In step 416, UE 402 determines that the a-CSI report is scheduled to be transmitted to gNB 401. In a first scenario, if the active DL BWP has been changed, then the a-CSI report may no longer be valid because the CSI measurements is over the first active DL BWP, and the UE is already operating in the second active DL BWP. In a second scenario, if the active UL BWP has been changed, then the allocated uplink radio resource for the a-CSI report transmission is associated with the first active UL BWP, and may no longer be valid because the UE is already operating in the second active UL BWP. As a result, UE 402 decides to drop the scheduled a-CSI report transmission.

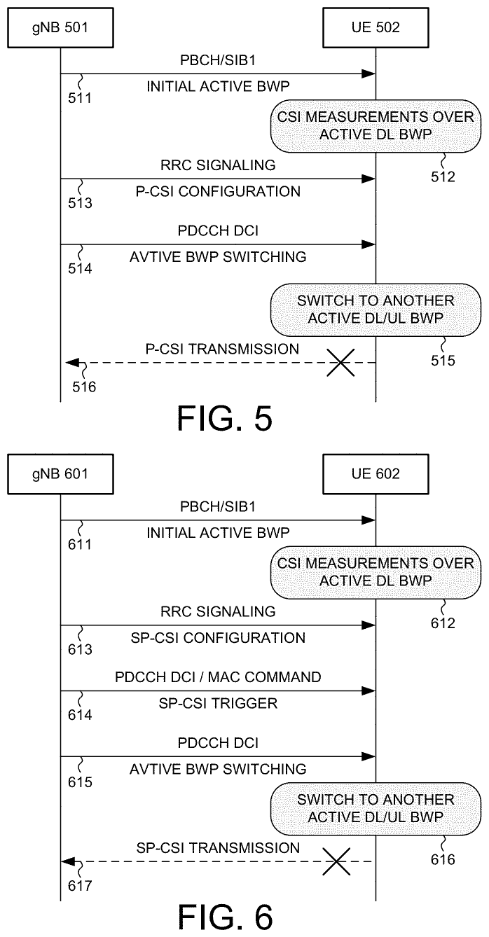

FIG. 5 illustrates a sequence flow between a base station and a user equipment for periodic channel state information (CSI) report with active BWP switching in a wireless communication system. In step 511, UE 502 receives configuration from gNB 501, e.g., from a physical broadcast channel (PBCH)/SIB1. UE 502 is configured with multiple DL and UL BWPs, and operates in an active DL BWP and an active UL BWP. In step 512, UE 502 performs CSI measurements over the active DL BWP. In step 513, UE 502 receives an RRC signaling. The RRC signaling configures the UE to transmit a periodic CSI (P-CSI) report over an allocated uplink radio source periodically. In step 514, UE 502 receives a PDCCH carrying a DCI. The DCI instructs the UE to switch the active DL BWP from the first DL BWP to a second DL BWP, and/or switch the active UL BWP from the first UL BWP to a second UL BWP. In step 515, UE 502 performs the active BWP switching, and UE 502 operates in the second DL BWP and/or the second UL BWP accordingly. In step 516, UE 502 determines that the P-CSI report is scheduled to be transmitted to gNB 501. In a first scenario, if the active DL BWP has been changed, then the P-CSI report may no longer be valid because the UE is already operating in the new active DL BWP. In a second scenario, if the active UL BWP has been changed, then the allocated uplink radio resource for the P-CSI transmission may no longer be valid because the UE is already operating in the new active UL BWP. As a result, UE 502 decides to drop the scheduled P-CSI transmission.

FIG. 6 illustrates a sequence flow between a base station and a user equipment for semi-periodic channel state information (CSI) report with active BWP switching in a wireless communication system. In step 611, UE 602 receives configuration from gNB 601, e.g., from a physical broadcast channel (PBCH)/SIB1. UE 602 is configured with multiple DL and UL BWPs, and operates in an active DL BWP and an active UL BWP. In step 612, UE 602 performs CSI measurements over the active DL BWP. In step 613, UE 602 receives an RRC signaling. The RRC signaling configures the UE to transmit a semi-periodic CSI (SP-CSI) report over an allocated uplink radio source semi-periodically. In step 614, UE 602 receives a first PDCCH carrying a first DCI or a MAC layer command. The first DCI or the MAC layer command activates UE 602 for the SP-CSI transmission based on the semi-periodic RRC configuration. In step 615, UE 602 receives a second PDCCH carrying a second DCI. The second DCI instructs the UE to switch the active DL BWP from the first DL BWP to a second DL BWP, and/or switch the active UL BWP from the first UL BWP to a second UL BWP. In step 616, UE 602 performs the active BWP switching, and UE 602 operates in the second DL BWP and/or the second UL BWP accordingly. In step 617, UE 602 determines that the SP-CSI report is scheduled to be transmitted to gNB 601. In a first scenario, if the active DL BWP has been changed, then the SP-CSI report may no longer be valid because the UE is already operating in the new active DL BWP. In a second scenario, if the active UL BWP has been changed, then the allocated uplink radio resource for the SP-CSI transmission may no longer be valid because the UE is already operating in the new active UL BWP. As a result, UE 602 decides to drop the scheduled SP-CSI transmission.

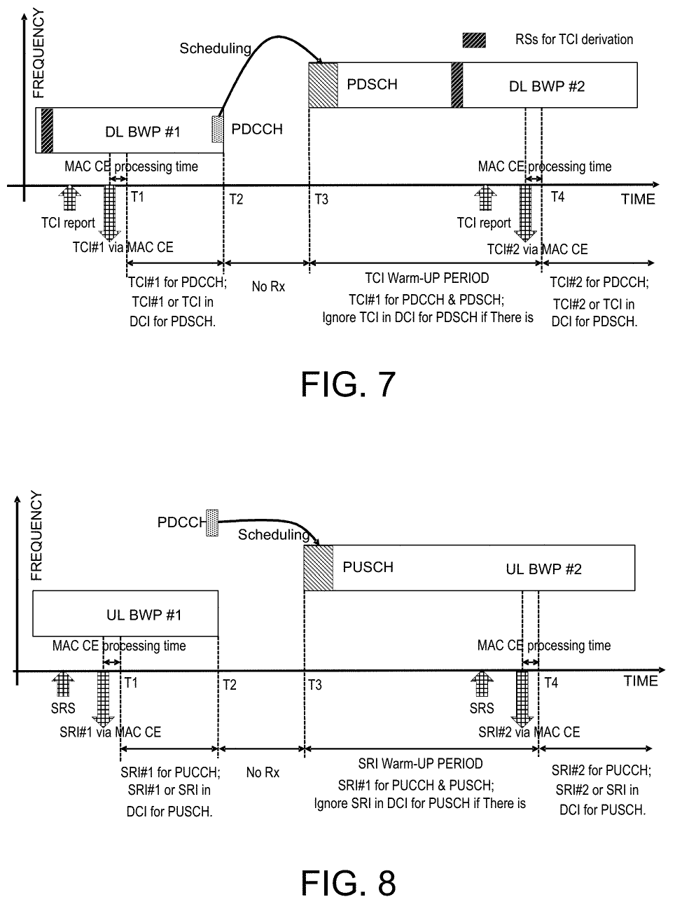

FIG. 7 illustrates one embodiment of downlink data transmission based on Transmission Configuration Indication (TCI) assumption with active BWP switching in a wireless communication system. In the example of FIG. 7, UE first operates in DL BWP#1. UE performs RS measurements for TCI derivation and sends TCI report to the base station. In response, UE receives TCI#1 from the base station. After a MAC CE processing time, at time T1, UE knows to use TCI#1 for PDCCH reception and to use TCI#1 or TCI in DCI for PDSCH reception when UE is operating in DL BWP#1. Later, at time T2, UE receives a PDCCH for a corresponding PDSCH reception. UE also performs active BWP switching, and UE is interrupted for signal reception during the switching until time T3. UE is scheduled for PDSCH reception after UE already switches to active DL BWP#2. Later, UE performs RS measurements for TCI derivation and sends TCI report to the base station. In response, UE receives TCI#2 from the base station. After a MAC CE processing time, at time T4, UE knows to use TCI#2 for PDCCH reception and to use TCI#2 or TCI in DCI for PDSCH reception when UE is operating in DL BWP#2.

However, from time T3 to time T4, there is a TCI-warmup period after UE switches to a new active DL BWP. During the TCI-warmup period, UE has not received any TCI from the network and does not know which TCI to use for PDCCH and PDSCH reception. It is proposed that UE continue to use TCI#1 during the TCI warmup period, which is the latest TCI for PDCCH reception in DL BWP#1, for PDCCH and PDSCH reception in DL BWP#2, until time T4, when UE receives TCI#2 via MAC CE becomes valid, and UE ignores the TCI in DCI for PDSCH if there is TCI field in DCI until time T4.

FIG. 8 illustrates one embodiment of uplink data transmission based on Sounding Resource Indication (SRI) assumption with active BWP switching in a wireless communication system. In the example of FIG. 8, UE first operates in UL BWP#1. UE sends SRS to the base station. In response, UE receives SRI#1 from the base station. After a MAC CE processing time, at time T1, UE knows to use SRI#1 for PUCCH transmission and to use SRI#1 or SRI in DCI for PUSCH transmission when operating in UL BWP#1. Later, at time T2, UE receives a PDCCH for a corresponding PUSCH transmission. UE also performs active BWP switching, and UE is interrupted for signal reception during the switching until time T3. UE is scheduled for PUSCH transmission after UE already switches to active UL BWP#2. Later, sends SRS to the base station. In response, UE receives SRI#2 from the base station. After a MAC CE processing time, at time T4, UE knows to use SRI#2 for PUCCH transmission and to use SRI#2 or SRI in DCI for PUSCH transmission when operating in UL BWP#2.

However, from time T3 to time T4, there is an SRI-warmup period after UE switches to a new active UL BWP. During the SRI-warmup period, UE has not received any SRI from the network and does not know which SRI to use for PUCCH and PUSCH transmission. It is proposed that UE continue to use SRI#1 during the SRI warmup period, which is the latest SRI for PUCCH reception in UL BWP#1, for PUCCH and PUSCH transmission in UL BWP#2, until time T4, when UE receives SRI#2 via MAC CE becomes valid, and UE ignores the SRI in DCI for PUSCH if there is SRI field in DCI until time T4.

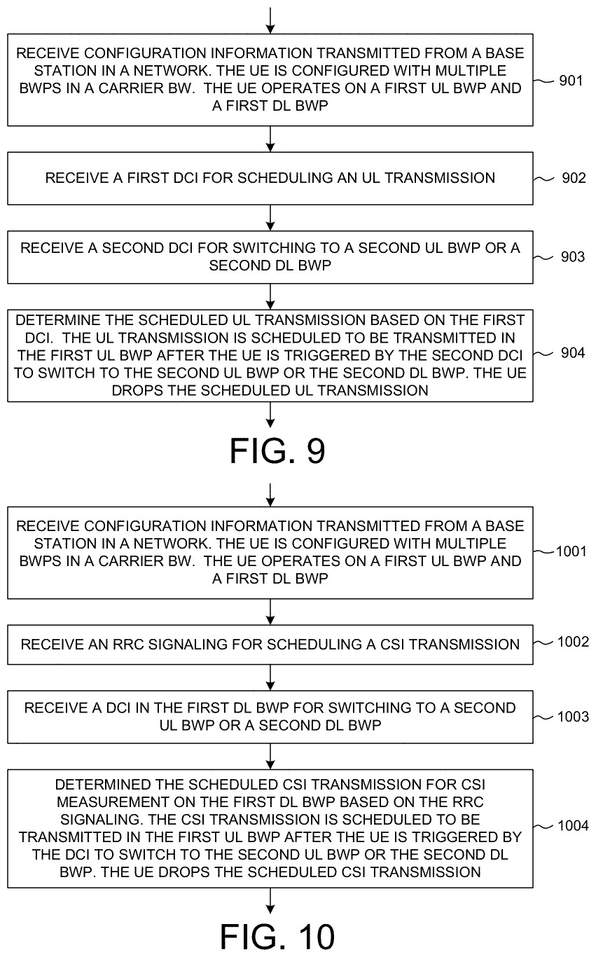

FIG. 9 is a flow chart of a method of SRS transmission during and after active BWP switching in a wireless communication system in accordance with one novel aspect. In step 901, a UE receives configuration information transmitted from a base station in a wireless communications network. The UE is configured with multiple bandwidth parts (BWPs) in a carrier bandwidth. The UE operates on a first uplink BWP and a first downlink BWP. In step 902, the UE receives a first downlink control information (DCI) for scheduling an uplink transmission. In step 903, the UE receives a second DCI in the first downlink BWP for switching to a second uplink BWP or a second downlink BWP. In step 904, the UE determines the scheduled uplink transmission based on the first DCI. The uplink transmission is scheduled to be transmitted in the first uplink BWP after the UE is triggered by the second DCI to switch to the second uplink BWP or the second downlink BWP, and the UE drops the scheduled uplink transmission.

FIG. 10 is a flow chart of a method of CSI reporting during and after active BWP switching in a wireless communication system in accordance with one novel aspect. In step 1001, a UE receives configuration information transmitted from a base station in a wireless communications network. The UE is configured with multiple bandwidth parts (BWPs) in a carrier bandwidth. The UE operates on a first uplink BWP and a first downlink BWP. In step 1002, the UE receives a radio resource control (RRC) signaling for scheduling a channel state information (CSI) transmission. In step 1003, the UE receives a downlink control information (DCI) in the first downlink BWP for switching to a second uplink BWP or a second downlink BWP. In step 1004, the UE determines the scheduled CSI transmission for CSI measurement on the first downlink BWP based on the RRC signaling. The CSI transmission is scheduled to be transmitted in the first uplink BWP after the UE is triggered by the DCI to switch to the second uplink BWP or the second downlink BWP, and the UE drops the scheduled CSI transmission.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving configuration information transmitted from a base station by a user equipment (UE) in a wireless communications network, wherein the UE is configured with multiple bandwidth parts (BWPs) in a carrier bandwidth, and wherein the UE operates on a first uplink BWP and a first downlink BWP;
receiving a first downlink control information (DCI) for scheduling an uplink transmission;
receiving a second DCI in the first downlink BWP for switching to a second uplink BWP or a second downlink BWP; and
determining the scheduled uplink transmission based on the first DCI, wherein the uplink transmission is scheduled to be transmitted in the first uplink BWP after the UE is triggered by the second DCI to switch to the second uplink BWP or the second downlink BWP, and wherein the UE drops the scheduled uplink transmission.

2. The method of claim 1, wherein the scheduled uplink transmission is a sounding reference signal (SRS) transmission.

3. The method of claim 2, wherein the UE operates in the first UL BWP while receiving the first DCI, and wherein the UE operates in the second UL BWP when the SRS is scheduled for transmission.

4. The method of claim 1, wherein the scheduled uplink transmission is an aperiodic channel state information (a-CSI) transmission.

5. The method of claim 4, wherein the UE operates in the first DL BWP when receiving the first DCI, and wherein the UE operates in the second DL BWP when the CSI is scheduled for transmission.

6. The method of claim 5, wherein the UE performs CSI measurements for the first DL BWP.

7. The method of claim 4, wherein the UE operates in the first UL BWP when receiving the first DCI, and wherein the UE operates in the second UL BWP when the CSI is scheduled for transmission.

8. A method comprising:
receiving configuration information transmitted from a base station by a user equipment (UE) in a wireless communications network, wherein the UE is configured with multiple bandwidth parts (BWPs) in a carrier bandwidth, and wherein the UE operates on a first uplink BWP and a first downlink BWP;
receiving a radio resource control (RRC) signaling for scheduling a channel state information (CSI) transmission;
receiving a downlink control information (DCI) in the first downlink BWP for switching to a second uplink BWP or a second downlink BWP; and
determining the scheduled CSI transmission for CSI measurement on the first downlink BWP based on the RRC signaling, wherein the CSI transmission is scheduled to be transmitted in the first uplink BWP after the UE is triggered by the DCI to switch to the second uplink BWP or the second downlink BWP, and wherein the UE drops the scheduled CSI transmission.

9. The method of claim 8, wherein the scheduled CSI transmission is a periodic CSI (P-CSI) transmission.

10. The method of claim 8, wherein the scheduled CSI transmission is a semi-periodic CSI (SP-CSI) transmission.

11. The method of claim 10, wherein the scheduled SP-CSI transmission is activated by a MAC-layer command.

12. The method of claim 8, wherein the UE operates in the first DL BWP when receiving the RRC signaling, and wherein the UE operates in the second DL BWP when the CSI is scheduled for transmission.

13. The method of claim 8, wherein the UE operates in the first UL BWP when receiving the RRC signaling, and wherein the UE operates in the second UL BWP when the CSI is scheduled for transmission.

14. A User Equipment (UE) comprising:
a configuration circuit that obtains configuration information transmitted from a base station in a wireless communications network, wherein the UE is configured with multiple bandwidth parts (BWPs) in a carrier bandwidth, and wherein the UE operates on a first uplink BWP and a first downlink BWP;
a receiver that receives a first signaling for scheduling an uplink transmission, wherein the UE also receives a second downlink control information (DCI) via physical layer signaling in the first downlink BWP for switching to a second uplink BWP or a second downlink BWP; and
a transmitter that determines the scheduled uplink transmission based on the first signaling, wherein the uplink transmission is scheduled to be transmitted in the first uplink BWP after the UE is triggered by the second DCI to switch to the second uplink BWP or the second downlink BWP, and wherein the UE drops the schedule uplink transmission.

15. The UE of claim 14, wherein the first signaling is a first DCI via physical layer signaling, and wherein the scheduled uplink transmission is a sounding reference signal (SRS) transmission.

16. The UE of claim 14, wherein the first signaling is a first DCI via physical layer signaling, and wherein the scheduled uplink transmission is an aperiodic channel state information (a-CSI) transmission.

17. The UE of claim 14, wherein the UE operates in the first UL or DL BWP when receiving the first DCI, and wherein the UE operates in the second UL or DL BWP when the uplink transmission is scheduled.

18. The UE of claim 14, wherein the first signaling is a radio resource control (RRC) signaling, and wherein the scheduled uplink transmission is a periodic or semi-periodic channel state information (P-CSI or SP-CSI) transmission.

19. The UE of claim 18, wherein the UE operates in the first DL BWP when receiving the RRC signaling, and wherein the UE operates in the second DL BWP when the P-CSI or SP-CSI is scheduled for transmission.

20. The UE of claim 18, wherein the UE operates in the first UL BWP when receiving the RRC signaling, and wherein the UE operates in the second UL BWP when the P-CSI or SP-CSI is scheduled for transmission.
